(19) United States
(12) Patent Application Publication
(10) Pub. No.: US 2018/0174136 A1
(43) Pub. Date: Jun. 21, 2018

(54) ALARM ACCESS OVERRIDE

(71) Applicants: Parveen Bansal, Foster City, CA (US); Aparna Krishnan Girish, Foster City, CA (US); Madhuri Chandoor, Foster City, CA (US)

(72) Inventors: Parveen Bansal, Foster City, CA (US); Aparna Krishnan Girish, Foster City, CA (US); Madhuri Chandoor, Foster City, CA (US)

(21) Appl. No.: 15/380,397

(22) Filed: Dec. 15, 2016

(51) Int. Cl. G06Q 20/36; G08B 25/14

(52) U.S. Cl. CPC G06Q 20/3674; G08B 25/14

(57) ABSTRACT

A property alarm, such as home alarm or car alarm, is analyzed for the nature of the alarm and when indicated causes access to one or more financial instruments to be limited or put on hold. Alarms for equipment failure may be ignored while alarms for an intrusion may trigger limiting access to the financial accounts. In some cases, a cap may be placed on transactions, risk rules for approving transactions may be increased, or a complete hold may be placed on some or all of the financial instruments.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An individual may have personal data stored at a residence, a business, or even in an automobile. When one of these locations is compromised, both the property and the personal data may be at risk.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

A system monitor may determine when a person's physical assets may be compromised and in response may take steps to proactively limit or disable access to a financial instrument whose information is among the physical assets. The alarm condition may cause these precautionary steps with respect to the financial instrument to be taken both when the person is on-scene or when the person is away from the physical asset being compromised.

### BRIEF DESCRIPTION OF THE DRAWINGS

FIG. 1 is a block diagram illustrating system elements for alarm access override of a financial instrument in accordance with the current disclosure;

FIG. 2 is a block diagram illustrating an alternate embodiment for implementing alarm access override;

FIG. 3 is a block diagram of an exemplary hardware device that supports alarm access override; and

FIG. 4 is a flowchart of a method of initiating and terminating alarm access override.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

Alarm access override limits access to a financial instrument when a property of the owner of the financial instrument may be, or is thought to be, compromised. When such a compromised condition is observed, steps may be taken according to pre-determined rules to limit access to the financial instrument. The user may set up both the conditions to be monitored and the rules to execute using a form or simply accept a default set of conditions and rules, also referred to as contingent actions. The contingent actions may be used at a transaction processor to increase risk rules used to evaluate a subsequent transaction, limit such transactions to a certain amount, or block transactions entirely. In some embodiments, online access to an account may be restricted. The rules or contingent actions may also include requirements for canceling the override such as logging into an account, entering a clearance code, or independent verification by a third party.

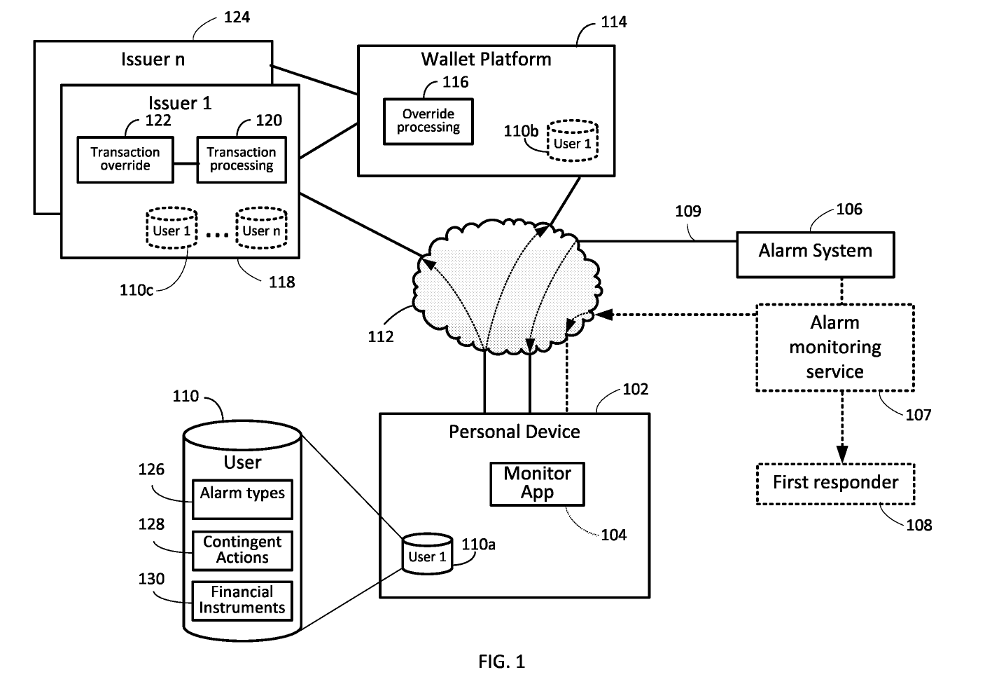

FIG. 1 is a block diagram generally illustrating one embodiment of a system for limiting access to a financial instrument responsive to an alarm. A personal device 102 may be, among others, a personal computer, home controller, or handheld device, such as a tablet or smart phone. The personal device 102 may have a monitor application 104 that is either installed and executed locally on the personal device 102, or may be client-side code running on a browser supported by a merchant or issuer 124 connected via network 112. For example, the monitor application 104 may be an application or browser code provided by a merchant or issuer 124 that supports a variety of transactions specific to that merchant or issuer 124.

While a merchant or issuer 124 are referred to in the following description, other entities may be represented in that role, such as a payment gateway. The role may also be represented by other product and service providers, such as an alarm monitoring service 107, utilities, travel providers, content providers, etc. While only the monitor application 104 is illustrated in FIG. 1, additional applications including other monitor applications may be supported simultaneously on the personal device 102. In various embodiments, applications supporting financial transactions, shopping, location, social media, entertainment, etc., may also reside on the personal device 102. The monitor application 104 may be a standalone application. In some embodiments, the monitor application 104 may be incorporated into another application, such as a home controller, a finance manager, or a local wallet application.

The alarm system 106 may be any of a number of systems that actively or passively monitor property of a user or property where a user's personal information may be stored. This may include a house, an apartment, a car, a boat, or a workplace, among others. The alarm system 106 may report an alarm condition to a monitoring service 107, which in turn may report the alarm condition to an appropriate first responder 108. The monitoring service 107 may then also report the alarm condition to the monitor application 104. In other embodiments, the alarm system 106 may directly send an alarm signal to the monitor application 104 via a network connection 109 whether or not an alarm monitoring service 107 is involved.

After receiving an alarm signal, the monitor application 104 may evaluate the alarm signal in view of an instance of user data 110, such as user data 110a stored in the personal device 102. The user data 110, may store alarm types 126, contingent actions 128, that is, rules for processing a particular alarm type 126, and financial instruments 130 that are to be impacted by the contingent actions 128. As shown in FIG. 1, the user data 110 may be embodied in different locations, including a wallet platform 114 or an issuer 118. These cases are discussed in more detail below.

The types of alarms received in the alarm signal may be varied, based on the nature of the sensors associated with the alarm system 106. For example, the alarm type may be related to a physical state of a home, such as under-temperature alarm type indicating perhaps a furnace failure or a high humidity or high temperature alarm type similarly indicating an air conditioning failure. The alarm signal may include alarm types related to whether certain lamps or appliances were left on or if a door is locked. Some other alarm types may indicate an unexpected condition that threatens a property but does not necessarily represent a risk to financial data, such as a basement water alert. These and similar alarm types would not generally cause concern related to the security of financial data. In these cases, the monitor application 104, based on the respective contingent actions 128, may notify the user of the alarm type or may simply ignore the alarm signal.

Some other alarm types may represent much more of a risk, including glass breakage, unplanned door opening, fire or smoke alarms, or unexpected movements in an interior of the property, as examples. These alarms may be identified in the alarm types 126 and have contingent actions 128 that limit access to designated financial instruments via an alarm access override. Alarms from an automobile or other vehicle may have similar counterparts, so that a low tire-pressure light may be ignored by the monitor application 104 but a window break may trigger an alarm access override. As mentioned above, the alarm signal received at the monitor application 104 may not be the only alarm signal sent by the alarm system 106 and the monitor application 104 may not be responsible for alerting the appropriate authorities relevant to the alarm, but could be in various embodiments.

The contingent actions 128 may map the alarm types to various actions to be taken upon receipt of an alarm signal having an actionable alarm type. In an embodiment, the alarm type may be mapped directly to a contingent action so that each actionable alarm type has a one-to-one mapping to a contingent action. In another embodiment, different alarm types may be categorized by threat level and assigned to a contingent action based on the threat level. For example, a door open alarm may cause a request to have a risk level for a financial instrument raised while a window break with motion alarm may cause the financial instrument to be blocked. An intermediate contingent action between a risk level increase and blocking a financial instrument may be to limit transactions to a particularly amount. Another intermediate contingent action may be to limit the cumulative total of all transactions to a given amount from the time the contingent action is set to when the contingent action is cleared.

The financial instruments 130 may be stored data of accounts for which alarm access override is to be applied. These financial instruments may be associated with credit and debit card accounts, merchant accounts, investment portfolios, online shopping accounts, or any other financial instrument that can be used for personal gain by a person in possession of the information. In one embodiment, the stored data may have one or more personal account numbers (PANs) or tokenized account numbers. In another embodiment, the stored data may be pre-populated executable links that when forwarded to a downstream entity cause a processor at the downstream entity to issue commands to limit access to the financial instrument or instruments identified in the executable link.

In the event that a user is present at property when the alarm is activated, the user may be under duress to complete a financial transaction. For this reason, one or more of the contingent actions may allow some level of activity with the financial instrument, or may return a message that does not indicate the alarm condition is the reason for a limited or rejected transaction. For example, a return message may indicate that there are insufficient funds for a transaction rather than explicitly referencing a security hold on the account.

A wallet platform 114 may accept instructions from the monitor application 104 that limit access to a financial instrument. In normal use, the wallet platform 114 may provide the user with more convenient and/or more secure transaction processing by holding details of financial instruments controlled by the user. For example, the wallet platform 114 may alternately hold user data 110b along with other data in a user wallet account in order to act on behalf of the user during transactions using tokens so that sensitive user data is not stored on a mobile device or exposed to a merchant during a transaction. In the illustrated embodiment, the wallet platform 114 may include an override processing module 116 that receives instructions from the monitor application 104 and may limit access to any of the financial instruments which are associated with the wallet platform 114. That is the wallet platform 114, in its role as an intermediary during a transaction, may reject a transaction or send instructions to one or more issuers 118, 124 to limit or reject transactions using specific financial instruments. Because the wallet platform 114 may be an aggregator of multiple financial instruments, the wallet platform may be an ideal location for implementing alarm access override.

However, in an alternate embodiment, monitor application 104 may also communicate directly with an issuer 118 to request that use of certain financial instruments controlled by the issuer 118 may be restricted. Therefore, upon receiving a request at a transaction processing module to use a particular financial instrument, a transaction override function 122 may interrupt normal processing in order to limit a transaction and to send a response to a transaction request in accordance with a selected one of the contingent actions 128.

As illustrated in FIG. 1, copies 100b and 100c of the user data 100 may be stored at the wallet platform 114 or an issuer 118 so that the monitor application 104 may defer processing of an alarm signal to either of those downstream entities. For example, in one embodiment, the monitor application 104 may simply forward the alarm signal to either of these downstream entities for the comparison of the alarm signal to the alarm types 126 and subsequent selection and implementation of a contingent action 128.

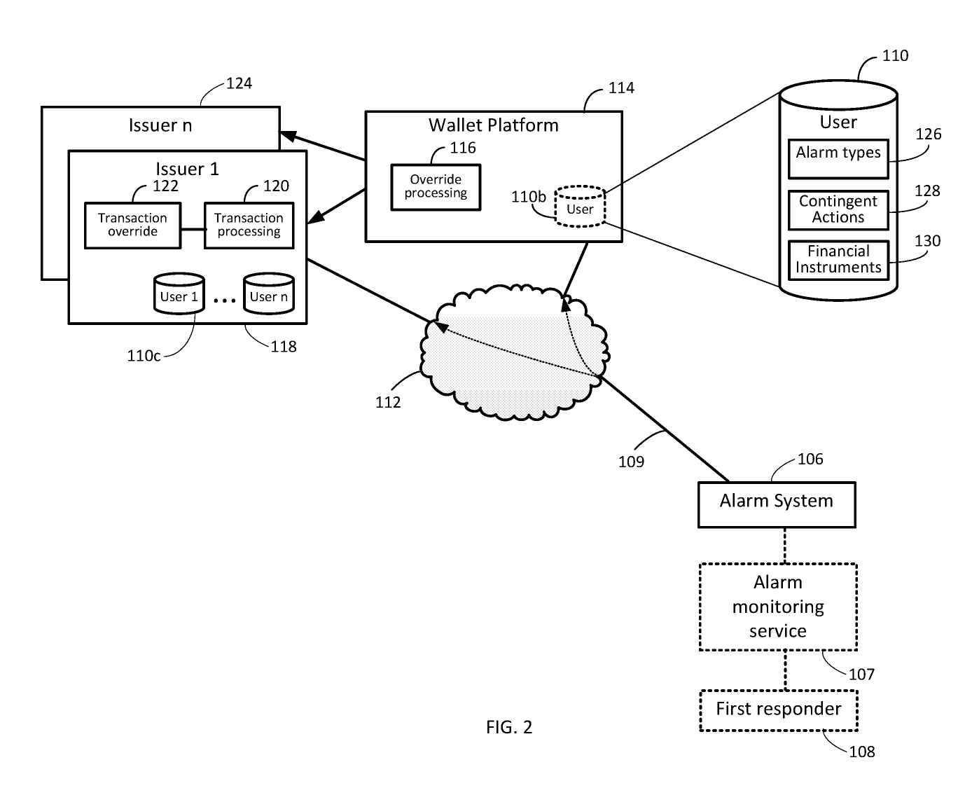

Deferring alarm processing to a downstream entity is more fully developed in the embodiment shown in FIG. 2. The block diagram of FIG. 2 shows operation of the alarm system override independent of any personal device associated with the user. In the various embodiments represented, the alarm system may independently send an alarm signal to the wallet platform 114 and/or one or more issuers 118, 124 via network connection 109 and wide area network 112. As above, user data 110 may be stored as separate instances 110b, 110c at the wallet platform 114, the issuer 118 or both.

In one embodiment, the alarm signal may be received at the wallet platform 114. The wallet platform 114 may use a processor with memory to parse the alarm signal to determine an alarm type 126 and then match the alarm type to a corresponding contingent action 128 associated with one or more financial instruments 130. As an aggregator of account information, the wallet platform 114 may serve as a clearinghouse for financial instruments 130 from a number of issuers 118, 124, or other accounts with potential exposure, such as investment accounts.

The wallet platform 114 may implement the appropriate contingent action or contingent actions via override processing module 116 by either blocking transactions from proceeding past the wallet platform 114 or by sending a message to the appropriate issuer indicating a potential compromise of a financial instrument. This message to the issuer 118 may be included in a regular transaction request or may be sent as a separate message, for example, out of band from the regular transaction processing channel. For example, in an embodiment, the wallet platform 114 may create and send a message including executable code that when stored and executed on a processor at the issuer 118, causes the issuer 118 to disable or limit access to the designated financial instrument.

As above, the alarm signal may be sent in a conventional fashion to an alarm monitoring service 107 or a first responder 108 in parallel with the message sent to a wallet platform 114 or issuer 118. In yet another embodiment, the alarm monitoring service 107 may be responsible for sending the alarm signal to the wallet platform 114 or an issuer 118.

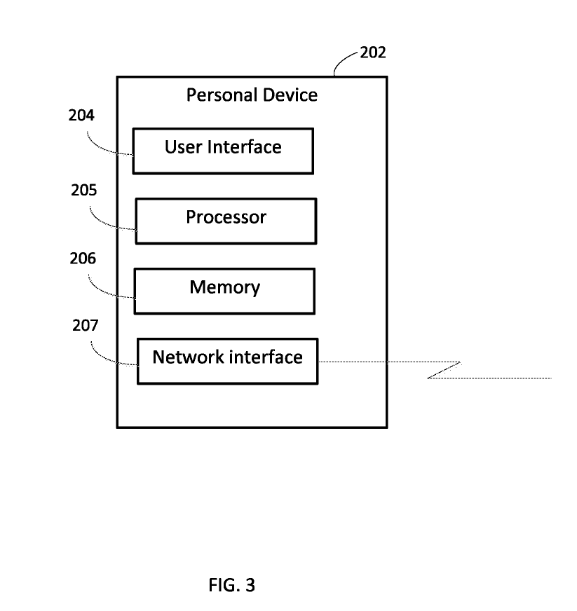

FIG. 3 is a simplified and representative block diagram of a personal device 202, the same as or similar to personal device 102 of FIG. 1. The personal device 202 may include a user interface 204 such as a touchscreen display or a simple display and discrete keyboard. A processor 205 and memory 206 may be used to store and execute code supporting different applications including the monitor application 104. The memory 206 may also store settings and other data, such as user data 110, illustrated in FIG. 1 as user data 110a.

The personal device 202 may also include a network interface 207 used to communicate with external entities such as the alarm system 106 and other entities via wide area network 112. The network interface 207 may include support for wireless connections via cellular data, WiFi and/or Bluetooth® as well as wired connections, for example, via a Universal Serial Bus (USB) physical port.

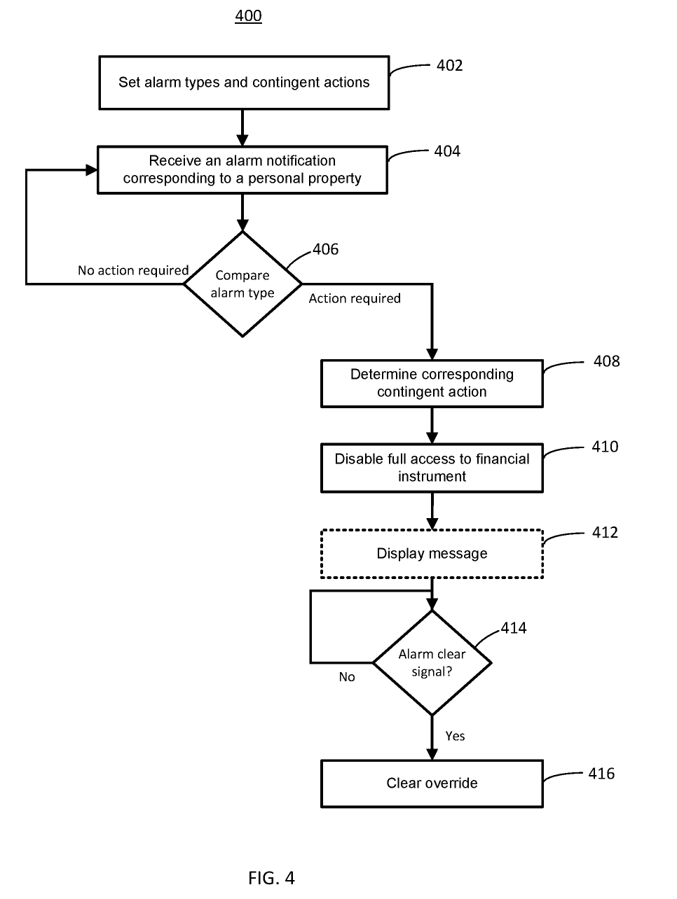

FIG. 4 is a flowchart of a method 400 of performing alarm access override by limiting access to a financial instrument of a person based on an alarm condition. At block 402, alarm types and related contingent actions may be saved at user data 110 or equivalent. The user data 110 may reside in any of several locations, including, but not limited to, a personal device 102, a wallet platform 114, or an issuer 118. As discussed above, the user data 110 may include alarm types 126, contingent actions 128, and financial instruments 130. In an embodiment, the user data 110 may be stored as a table, such as Table 1 below:

TABLE 1

| Alarm type | Contingent action | Financial instrument |
|---|---|---|
| Low temperature alert | None | — |
| Fire | Limit cumulative total | Citibank Visa, |
| | transactions | Retirement account |
| Home Intrusion | Stop all instruments | All |
| Car alarm | Raise risk level | Debit and credit |
| | | instruments |

As illustrated in Table 1, some alarm types have little to no implications for personal data security and have no corresponding contingent action. Other alarm types may have contingent actions set based on the perceived level of risk, as shown. The alarm types 126 and contingent actions 128 may be customized, for example, by a user, based on the type of alarm system 106 and what it is capable of reporting, as well as the contingent actions 128 available with respect to the user's various financial instruments. In an embodiment, any of the systems which may store or process the user data 110, such as the personal device 102, the wallet platform 114, or an issuer 118 may use an application program interface (API) to expose methods for capturing alarm types and contingent actions or responses to the various alarm types. These methods may be accessed by any of a number of user interfaces available at the personal device 102, alarm system 106, wallet platform 114, or other system so that a user or installer can input these data.

At block 404, an alarm notification may be received from a personal property alarm of the person. The alarm may be from a home, a business, a guest house, an automobile, or even a personal article, such as a briefcase. At block 406, the received alarm notification may be matched to the set of alarm notification types in order to determine a response. As illustrated above, some alarm types require no action, so the branch “No action required” may be taken to block 404 to wait for another alarm notification. When a match requiring action is made, execution may follow the indicated branch to block 408. There, the contingent action 128 corresponding to the alarm type 126 may be identified. That is, the contingent action 128 corresponds to an alarm notification type that corresponds to a potential compromise of personal data.

At block 410, full access to the financial instrument may be disabled by taking an action in a range from raising a risk level for transactions as they are requested to putting a proactive hold on all accounts associated with financial instruments held by the user. As discussed above, the contingent action may be selected to match a risk associated with a particular incident being reported by the alarm notification. For particularly sensitive financial instruments, online access to the account may be disabled until verified through some personal mechanism, such as appearing in person at a bank branch.

In an embodiment, a message that reports a change in status of one or more financial instruments may be reported to the user, for example, via the monitor application 104, as shown at block 412. In embodiments such those illustrated in FIG. 2, the message may be sent to a user via email, text message, or other communication mechanism.

At block 414, polling may occur to determine whether an alarm clear signal has been received from either the alarm system 106 itself or from the user or user's agent. The alarm clear may be separate signal from the alarm system indicating that a user or authorized person has entered a passphrase or other signal. Upon receipt of an alarm clear signal, the alarm access override may be removed and the operation of all financial instruments returned to a normal operating status with pre-alarm risk levels and pre-event financial limits restored. In the same way that the alarm access override may be implemented at various places in the financial processing chain, clearing the override may be implemented at those same places.

The alarm access override provides a benefit to both individuals and financial institutions. When a personal space has been violated, a person may be immediately concerned with verifying the safety of loved ones, interacting with the authorities, and overcoming a feeling of violation. Remembering each possible account at risk, finding relevant contact information and account data for any number of financial instruments, making those contacts and seeing that the financial instruments are limited or canceled may not be easily or quickly completed. The ability of the alarm access override to respond efficiently and accurately to various situations provides peace of mind and account protection for the individual.

Financial institutions also benefit through the efficient notification that various accounts may have been compromised by blocking access to financial instruments before a bad actor has a chance to run up charges for which the institution will be responsible.

A technical effect of alarm access override is seen in, for example, the monitor application 104 that accepts data from a physical property alarm system 106 to provide a capability not found in prior art alarm systems. In another example, the alarm system 106 itself may be modified to directly contact the monitor application 104 or another downstream financial system 114, 118.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of limiting access to a financial instrument of a person based on an alarm condition, the method comprising:
receiving, from a property alarm, an alarm notification corresponding to a personal property of the person, the alarm notification including an alarm type;
comparing the alarm notification to a set of alarm types;
based on the comparison, determining that the alarm type corresponds to a potential compromise of personal data; and
disabling full access to the financial instrument responsive to determining the alarm type corresponds to the potential compromise of personal data.

2. The method of claim 1, further comprising:
generating the set of alarm types.

3. The method of claim 1, wherein receiving, from the property alarm, the alarm notification comprises receiving the alarm notification at a wallet account of the person, the wallet account storing information corresponding to the financial instrument.

4. The method of claim 1, wherein receiving, from the property alarm, the alarm notification comprises receiving the alarm notification at an issuer of the financial instrument of the person.

5. The method of claim 1, wherein receiving, from the property alarm, the alarm notification comprises receiving the alarm notification at an application of a personal device of the person.

6. The method of claim 1, wherein the set of alarm types includes a home break-in type, a car break-in type, a business break-in type, and a home fire type.

7. The method of claim 1, wherein disabling full access to the financial instrument comprises denying a transaction using the financial instrument.

8. The method of claim 1, wherein disabling full access to the financial instrument comprises increasing a risk rating on a transaction using the financial instrument.

9. The method of claim 1, wherein disabling full access to the financial instrument comprises setting a maximum transaction value for a transaction using the financial instrument.

10. The method of claim 1, further comprising restoring full access to the financial instrument responsive to receiving an alarm clear signal.

11. The method of claim 10, wherein the alarm clear signal is one of a passphrase received from the person and receiving an all clear from the property alarm.

12. A system for limiting access to a financial instrument comprising:
a processor and memory configured to execute instructions stored in the memory;
a network interface that communicates via a network with an alarm system;
a first data set stored in the memory that contains data corresponding to a plurality of alarm types;
a second data set that stores response information relative to the financial instrument for each of the plurality of alarm types; and
executable instructions stored in the memory that when executed cause the processor to:
receive an alarm notification from the alarm system, the alarm notification including an alarm type;
match the alarm type to one of the plurality of alarm types in the first data set;
select a response from the response information of the second data set corresponding to matched alarm type; and
send a signal that causes access to the financial instrument to be limited according to the selected response.

13. The system of claim 12, further comprising a user interface that accepts input for populating the first data set.

14. The system of claim 13, wherein the user interface further accepts input for populating the second data set.

15. The system of claim 12, further comprising an application program interface that exposes a method for populating one of the first data set and the second data set.

16. The system of claim 12, wherein the selected response is one of an instruction to deny transactions associated with the financial instrument and an instruction to limit a value of a transaction associated with the financial instrument.

17. The system of claim 12, wherein the selected response is one of an instruction to increase a risk rating of a transaction associated with the financial instrument.

18. A method of providing instructions related to the use of a financial instrument responsive to an alarm notification, the method comprising:
storing, using a processor and memory, a plurality of responses to respective alarm notifications;
receiving, at the processor, an alarm notification via a network from an alarm system;
matching the alarm notification to a respective one of the plurality of responses; and
sending a signal corresponding to the matched one of the plurality of responses that causes a transaction processor to limit access to the financial instrument.

19. The method of claim 18, wherein sending the signal causes the transaction processor to raise a risk rating of a transaction using the financial instrument.

20. The method of claim 18, further comprising receiving an all clear from one of the alarm system and a verified party with an interest in the financial instrument.
